(19) United States
(12) Patent Application Publication
(10) Pub. No.: US 2005/0275288 A1
(43) Pub. Date: Dec. 15, 2005

(54) Boat trailer cutout switch

(76) Inventor: David Duane Miller, Denver, CO (US)

Correspondence Address: DAVID D. MILLER, 1588 S. NEWTON ST., DENVER, CO, 80219, US

(21) Appl. No.: 10/746,725

(22) Filed: Jun. 9, 2004

(51) Int. Cl. B60L 1/00

(52) U.S. Cl. 307/10.1

(57) ABSTRACT

The boat trailer cutout switch is convenient alternative to unplugging a boat trailer before submerging the trailer in water. This system will allow the operator to discontinue the flow of electricity to the trailer while seated in the drivers seat of the tow vehicle. It will also give the operator visible and audio cues as to the mode of operation and the output of the system. The operational mode function will cause a light to illuminate and an audio devise to sound when no electricity is being sent to the trailer. The output function will illuminate a light for either turn signal as a flashing light or brake lights in a continuous light. The running lights will illuminate a separate light. Both signal inform the operator of electricity leaving the system. This system will be easily bypassed incase of malfunction and will self energize when coupled to the boat trailer.

### FIELD OF THE INVENTION

The boat trailer cutout switch provides a convenient way to disrupt the flow of electricity from a tow vehicle to a boat trailer when a boat is launched or retrieved from a body of water. When a boat trailer is submerged, as is needed to launch or retrieve a boat from a body of water, with the trailer light system energized, then there is a chance that the hot bulbs will burst when they contact the cooler water. Not only will this disable the bulb, but this could also blow the lighting fuse in the tow vehicle. With the lighting fuse blown out the vehicle lighting system would be disabled and the vehicle would be rendered unsafe to drive.

As is the common practice now, when a boat and trailer arrives at a river or lake, it is parked some distance from the boat ramp (the launching and retrieving point) and readied for launching. The boat is untarped, the trailer to boat tie downs are removed, and the trailer to tow vehicle electrical plug is disconnected to cease the flow of electricity to the trailer. The boat and trailer is then towed to the boat ramp with no lighting by the tow vehicle. After launching the boat, the tow vehicle and trailer is then driven to a parking space. The electrical plug is rarely reengaged during this process because, after the boat is used this process is reversed and the electrical connection would be disconnected to retrieve the boat from the body of water. During the time from the launching to the retrieving of the boat it is not unusual for the trailer plug to drag on the ground causing damage to the connector. Also at recreation areas with a high volume of boat traffic a remote area can be used to set up a waiting line for the use of the boat ramp. This increases the distance a trailer would need to be towed without lighting causing safety concerns. When the boat is launched or retrieved in the hours of darkness or in inclement weather then a low to the ground unlit boat trailer would heighten the safety concerns to other motorists. Then there is always the concern of a person forgetting to connect or reconnect the trailer plug and towing an unlit boat trailer.

This invention would eliminate all of these adverse situations by allowing the operator of the tow to control the electrical flow to the boat trailer at the boat ramp from the convenience of the cab of the tow vehicle. With the incorporated indicator lights and audio alarm the operator would have a visual reminder to energize or de-energize the cutout switch as appropriate. The indicator lights also assure the operator of the tow vehicle that the trailer plug is connected and that electricity is flowing through the switch. Other attributes of this system are that the boat trailer cutout switch is not activated or functional with any trailer other than the boat trailer, and if the boat trailer cutout switch malfunctions it will be apparent through the indicator lights and is easily bypassed.

### PRIOR ART

The specific problem of controlling the electrical flow to a boat trailer during submersion has been addressed in prior patents. In one prior U.S. Pat. No. 4,620,109 (Kummer) two present vehicle electrical circuits are used to activate the control module. Both circuits had to be energized simultaneously. This requires a conscious participation by he operator of the tow vehicle. The circuits involved are the headlight circuit and the backup light circuit. The operator was required to turn on the headlights as they shifted into reverse. This could be inadvertently done while backing out of a parking place at night allowing the vehicle drive on a public street without trailer lights.

The boat trailer cutout switch also requires a conscious participation by the operator of the tow vehicle to activate a manual switch, but in addition cues the operator visually as to the control modules electrical functions through indicator lights and an audio alarm. Through the indicator lights, the operator of the tow vehicle has no question as to the operation or the operational mode of the boat trailer cutout switch. This system also cues the tow vehicle operator that the tow vehicle is connected to the boat trailer.

In U.S. Pat. No. 5,285,113 (Schlich) the system relies on a float at the rear of the boat trailer activates or deactivates a switch to power the unit. Running electricity to a submerged portion of the boat trailer is what is being avoided by this invention. The use of a float at the rear of a boat trailer would need to be at a low enough position to allow for time for the light bulbs to appropriately cool before being submerged. This could subject the float to damage from road hazards such as backing up a curb or steep drive. Schlich's system relied on a capacitor to allow time for draining before reactivation of the trailer lights suggesting the need for an appropriate length of time needed before heating the trailer bulbs similar to the cooling time aforementioned. Schlich's system is designed to be automatic and does not rely on operator input, nor does it signal the operator as to the function of the unit.

Both of the previously discussed patents use extensive circuitry to activate and deactivate the control unit which the boat trailer cutout switch does not use. The boat trailer cutout switch utilizes a simple manually activated switch controlling a solenoid. The indicator lights are connected to the outlet side of the control mechanism with simple diodes to prevent unwanted feedback and are independent from the control mechanism. A malfunction of the indicator light or audio alarm will not affect the functioning of the control mechanism. The whole of the system is grounded through the modified boat trailer with a separate connector on the trailer and tow vehicle plug. This allows any other trailer to be used without activating the boat trailer cutout switch. Most standard plugs on the market have an unused pin to accommodate the wiring needed.

The main control unit shown in U.S. Pat. No. 5,285,113 (Schlich) and U.S. Pat. No. 4,620,109 (Kummer) are similar to what is offered in the boat trailer cutout switch schematic but no specific structure is shown or suggested. Part of the novelty and originality of this invention is in the construction of the control unit. One half of the main control unit body is the same as its counterpart turned 180 degrees. Thus only one mold is needed to manufacture the main control unit body. Although many manufacturing techniques could be utilized to produce this product it is my belief that plastic injection molding would be the most economical. There is only one moving part incorporated in the main control unit to connect and disconnect three or more circuits. The moving part is the plunger and the plunger would be mechanically moved with a solenoid. The mount for the solenoid could be incorporated into the main control body or made as a separate piece and attached. The plunger and the solenoid mount could also be made by many manufacturing techniques but again it is my belief that plastic injection molding would be the most economical. Plastic injection molding is readily available and widely used technology. All other components in the boat trailer cutout switch are common and readily available.

### SUMMARY OF THE INVENTION

The boat trailer cutout switch gives the operator of a tow vehicle a convenient means to control the electrical current flow originating at the tow vehicle and flowing to the towed boat trailer from inside the cab of the towing vehicle. This system also gives the operator of the towing vehicle visual and audio cues as to the operation and operational mode of the control devise. Running lights are shown to be on by a steady amber light. Turn signals are shown by a flashing green light. The same green light indicates the brake lights are activated with a steady illumination. With the boat trailer cutout switch activated and no electrical flow going to the boat trailer both the amber and the green indicators will cease to operate and a red light will illuminate and an audio alarm will sound. Any variance from this arrangement would signal a malfunction. A malfunctioning main control switch may be bypassed easily. Locate the main control switch in the trunk of the vehicle or on the rear frame of the vehicle. Unplug the vehicle output form the vehicle plug of the main control switch, then unplug the main control switch trailer plug from the trailer input plug. The vehicle output plug may then be connected to the trailer input plug effectively bypassing the boat trailer cutout switch.

With the convenience of a cutout switch and the indicator lights within the reach of the tow vehicle operator a boat could be launched and retrieved from a body of water without having to physically disconnect the trailer lighting system. Having the operator possess the ability to stop the flow of the electricity to the trailer and the indicator lights and audio alarm to monitor the system would enhance the safety of the tow vehicles electrical system and the movement of the vehicle at and around the boat launching ramp.

Through the wiring of the boat trailer cutout switch, the system will only activate when it is coupled to a modified trailer plug. This wiring system prevents the boat trailer cutout switch being activated unnecessarily limiting wear. It also shuts down the system when no trailer is being towed. The system may be wired to any configuration of trailer plug. This same wiring method allows the system to be easily bypassed in the event of a system malfunction. Without having to unplug the trailer connections, the dangling plugs will not be dragging on the ground causing damage.

The simplicity of the and the identical construction of the two piece main control body, one half being the same as the other only inverted, will allow for economical manufacturing and affordability to the boating public. The installation of the system will be uncomplicated. The system will be comprised of a main control body with input and output plug, a switch and indicator light assembly, and a length of four wire harness to connect the indicator light assembly to the main control body. A do it yourself person will be easily capable of the installation process. With all plugs being of a normal boat plug configuration the main control body can plug into an existing vehicle trailer plug. Then the modified boat trailer plug would simply be spliced in with the extra wire being connected to ground.

### SCHEMATIC AND DRAWING DESCRIPTION

FIG. 1 is multiple views of one half of the main control body unassembled. (A) is a side view. (B) is a view from the top. (C) is a frontal view.

FIG. 2 shows a top view of (A) the two halves shown in FIG. 1 combined. (B) a detached solenoid mount and solenoid. And C a plunger assembly with return spring.

FIG. 3 illustrates a mechanical version of the main control body with all wiring and hardware in place.

FIG. 4 is a full wiring schematic of the boat trailer cutout switch system including disconnect switch, indicator lights, main control body wiring with diodes and solenoid, vehicle plug, and trailer plug.

### DETAILED DESCRIPTION OF THE INVENTION

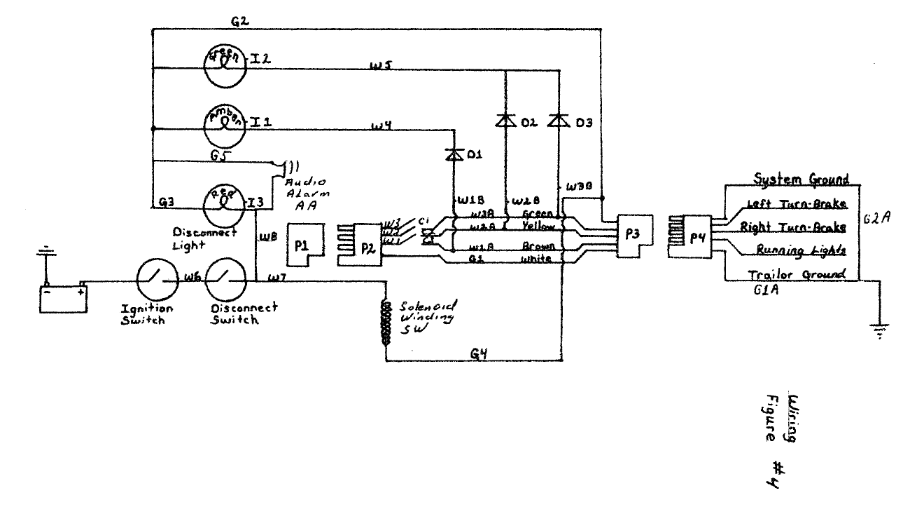

The operation of this system has been intentionally made as simple as possible to enhance durability, dependability, and economic feasibility while maintaining as many advantageous features as possible. In the following explanation all coded parts in parenthesis will be found on FIG. 4 the wiring schematic. Corresponding parts from separate drawings will be noted by the respective figure number. The illustrations are not meant to limit this invention but are an exact reproduction of a working proto-type made under outmoded conditions without the use of modern technology.

By law a unit in the tow of another vehicle must have appropriate lighting. The nature of a boat trailer, to be useful must deliver a boat to and from a body of water and must have the capability to deposit the boat into that body of water. To do the latter the trailer lighting system must be disconnected at some point in time to prepare it for submerging. The disconnection is advantageous for the protection of the electrical circuitry of both the boat trailer and the tow vehicle. This invention is designed to accommodate that disconnection in a safe, monitored, and convenient manner. To accomplish this there are two positions for this system, trailer lights functioning (solenoid at rest) and trailer lights nonfunctioning (solenoid energized). these will be explained in detail later.

The boat trailer cutout switch has two distinct components. The main control switch which connects and disconnects the vehicle lighting circuits from those of the trailer. The main control switch should be mounted near the rear of the vehicle, preferably in the truck of an automobile or along the frame of a truck. The other component would be the disconnect switch and monitoring panel which would be located within convenient reach of the vehicle operator.

### Trailer Lights Functioning

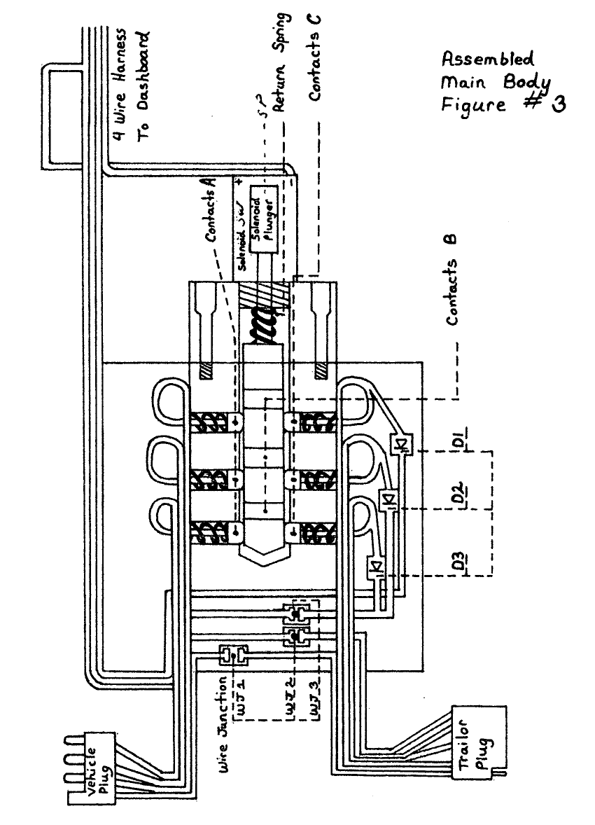

With the disconnect switch at the dashboard, in the open position, electricity from the vehicle lighting system will enter the boat trailer cutout system through the vehicle plug (P1) to the system plug (P2). From system plug (P2) the three separate circuits will flow through a brown wire (W1) for the running lights, a yellow wire (W2) for the right brake light and turn signal, and a green wire (W3) for the left brake and turn signal light into the main control switch. The colors described are the common colors for trailer plugs in the industry. Once in the main control switch the individual circuits will to contacts A, across contacts B, on the plunger to contacts C on the opposing side as shown on FIG. 3. This series of contacts are shown collectively on FIG. 4 as switch (S1). From switch (S1) the individual circuits would flow to wires (W1A), (W2A), and (W3A) and leave the main control switch and travel to system plug (P3) to connect to the trailer plug (P4). These wires leaving the main control switch would correspond in color to the wires entering the main control switch, (W1) and (W1A) would be brown and so on. The ground wire, (G1) white in color, would run affectively uninterrupted from system plug (P3) to trailer plug (P2). A junction WJ1 as shown on FIG. 3 could be used for ease of assembly. With plug (P1) connected to plug (P2) and plug (P3) connected to plug (P4) this would complete all circuits for vehicle to trailer lights. While still in the main control switch three wires (W1B), (W2B) and (W3B) would branch from (W1A), (W2A) and (W3A) respectively. Each of these wires would have an inline diode (D1), (D2) and (D3). The purpose of the diode would be to prevent any feedback or common grounds from later connections. From diode (D1) electricity, derived from the running lights, would be channeled through wire (W4) to the amber light (I1) on the dashboard mounted monitoring panel. Both diodes (D2) and (D3) would connect to wire (W5) on the out bound side and run to a green light (I2) on the monitoring panel. Junction WJ3 maybe added for ease of assembly as shown on FIG. 3. The green light (I2) will respond to the brake lights or either turn signal being activated. Both indicator lights (I1) and (I2) will show continuity through the main control switch. They will not insure that the trailer lights or wiring are in working order. These should be visually checked according to manufactures recommendation. Both indicator lights will have a common ground wire (G2). The common ground wire (G2) would return to the main control switch. Ground wire (G2) will pass through the main control switch uninterrupted and exit the main control switch continuing on to plug (P3). Again a junction, WJ2, in the main control switch maybe added for ease of assembly, as shown on FIG. 3. Upon inspection it may be seen that plugs (P1) and (P2), entering the main control switch, have four connecting prongs, while plugs (P3) and (P4), leaving the main control switch, have five prongs. The extra connection in plugs (P3) and (P4) would be for wire (G2) and corresponding wire (G2A) our system ground. The wire (G2A) would connect to trailer ground (G1A) after plug (P4). If a four prong were to be plugged into plug (P3) then the indicator lights would become nonfunctional. Also, as an option, wire (G2) could be vehicle grounded rendering the indicator lights full functioning at all times even when no trailer was being towed. An additional switch directing this ground to the vehicle or to the plug (P3) could be added in this circuit to customize the system to the desires or use of the consumer. Because a four prong plug can be utilized with the five prong plug, then plug (P1) can be connected to plug (P4) effectively bypassing the boat trailer cutout switch system. This is very desirable in the event of a malfunction of the main control switch. With the system ground wire grounding at the trailer the boat trailer cutout switch would be disabled when no trailer was being towed.

### Trailer Lights Nonfunctioning

With the disconnect switch (S1) in the closed position, allowing electricity to flow along wire (W7) the solenoid (SW), at the main control switch, would be energized. The solenoid would retract the solenoid plunger, SP, and the attached main plunger disaligning contacts, B, with contacts, A, and, C, as shown on FIG. 3. In wiring FIG. 4, this would open switches (C1), (C2), and (C3) disallowing the flow of electricity from the vehicle to the trailer. The electricity from solenoid (SW) would then flow through wire (G4) to wire (G2), the system common ground to complete the circuit. Wire (W8) would lead to a red indicator light (I3), then continue to an audio alarm devise (AA). the indicator light and audio alarm would be in a parallel circuit allowing either to energize even though the other was malfunctioning. This would alert the operator that there was electricity going to the main control switch solenoid and the boat trailer cutout switch was engaged. The electricity would connect to the common ground (G2) through wires (G3) and (G5). If there were a malfunction at the main control switch to prevent the plunger assembly to retract then the indicator lights (I1) and (I2) would continue to function warning the operator that there is a problem.

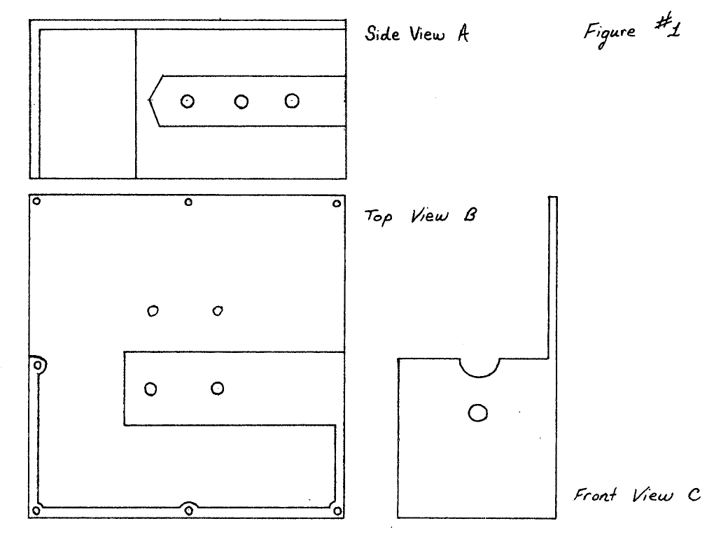

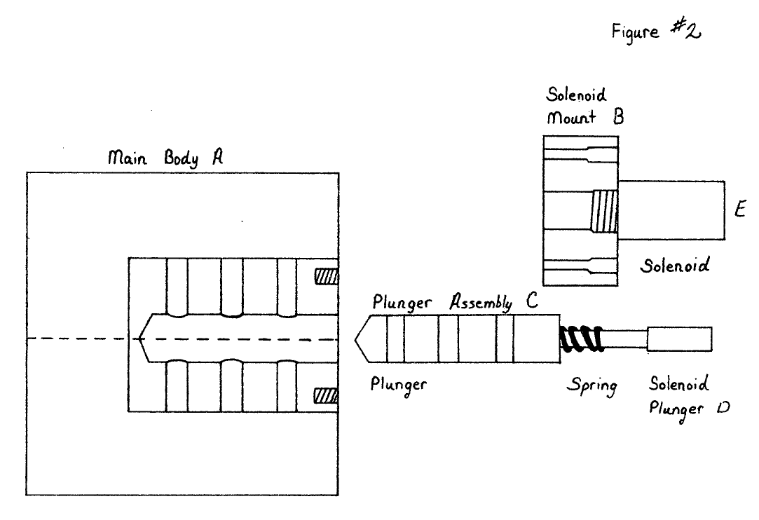

The manufacturing of the main control switch box, as shown in FIG. 1, would be made of plastic utilizing plastic injection molding. Two of these pieces could screwed or snap together to form the body of the main control switch. Although screws would be preferred for strength and stability. Each half would be identical to the other. The half sphere, as shown on the front view C, would come together with its identical counterpart to form the cylinder for the plunger, as shown in FIG. 2 main body A, and plunger assembly C. The plunger assembly, FIG. 2 C, would also be made using plastic injection molding. Brass contact rings would be set into the mold and the plastic would be injected through then. A hole would be drilled and tapped with threads into the end for the solenoid plunger, FIG. 2 D. A return spring would be added to the solenoid to return the alignment of the contacts. The return spring will also seat the cone shaped end of the plunger into the cone shaped end of the cylinder of the control switch main body, also shown in FIG. 2. The purpose of the cone shape end of the cylinder and plunger is to stabilize the plunger against the everyday vibrations of driving decreasing wear of components. The solenoid mount could be made with plastic injection molding or simply cut from a piece of plastic stock then appropriately drilled and tapped for threads. Solenoid are a common item and come in various strengths and voltage options. Because of these options additional contacts may add for current demands or electric trailer brakes. Furthermore voltages could be modified for demands in future automotive designs.

1. A system for allowing the operator of a towing vehicle to monitor, discontinue and reconnect electrical flow to a boat trailer from the convenience of the drivers seat, while delivering or retrieving a boat from a body of water consisting of;
a) the monitoring panel containing indicator lights, and an audio alarm and a disconnect switch to energize or de-energize;
b) the main control switch comprised of two identical body halves, a vehicle plug for input, a modified trailer plug for output, diodes to supply the individual indicator lights, a solenoid connected to a plunger assembly which allows or discontinues electrical flow to the;
c) the modified trailer plug set to supply the trailer circuitry with appropriate current as needed for the various lighting and to ground the boat cutout switch's circuitry.

2. Indicator lights according to claim 1 a), meaning a set of three lights of different distinct colors, the first of which would monitor current going to the main control switch from the disconnect switch to monitor the mode of operation of the main control switch, the second to monitor the current exiting the main control switch to the running lights of the trailer, and the third to monitor the current exiting the main control switch to the turn signals and brake lights.

3. Two identical body halves according to claim 1 b) would mean the top half of the main control switch would be an exact copy of the bottom half, these pieces are interchangeable.

4. Plunger assembly according to claim 1 b) is of a cylindrical shape made of plastic for its electrical nonconductive qualities and has at least three contact areas that will conduct electricity with the contact areas to be separated by the nonconductive material with one end having a means to connect it to a solenoid and the other end in a cone shape for stability when at rest.

5. Disconnect switch according to claim 1 a) would mean an electrical switch within the reach of the operator to supply or disrupt a flow of electricity to the solenoid incorporated in the main control switch and connected to the plunger which would when energized move the plunger to misalign the plunger electrical contacts from the main control switch body electrical contacts to disrupt electrical flow to the modified trailer plug.

6. Audio alarm according to claim 1 a) would be a sounding devise to be set in a parallel circuit with the disconnect switch indicator light to warn the operator that the solenoid incorporated in the main control switch is energized and no electrical flow is being allow to the trailer lighting circuits.

7. Diodes according to claim 1 b) would mean a set of three diodes allowing electricity to flow in one direction only away from the circuit being monitored to the indicator light and stopping current from flowing back to the monitored circuit, the first diode to monitor the running lights, the second and third for the respective turn signals which also activate the brake lights, spliced in on the outlet side of the main control switch to monitor current being passed through the main control switch.

8. Modified trailer plug according to claim 1 c) would be any standard trailer plug of any configuration utilizing a unused connector to complete a ground for the boat trailer cutout switch by grounding the boat trailer cutout switch to the boat trailer then in turn be grounded to the vehicle through the vehicle-trailer ground this will disable the system when any other trailer with a standard plug or no trailer is connected to the system.

9. System according to claim 1 is all the components and the wiring needed to connect the components of the boat trailer cutout switch to enable it into a working system as mentioned in claims 1 thru 8.
